(19) United States
(12) Patent Application Publication
(10) Pub. No.: US 2020/0097434 A1
(43) Pub. Date: Mar. 26, 2020

(54) ENHANCED HIGH DATA RATE TECHNIQUE FOR I3C

(71) Applicant: QUALCOMM Incorporated, San Diego, CA (US)

(72) Inventors: Lalan Jee MISHRA, San Diego, CA (US); Radu PITIGOI-ARON, San Jose, CA (US); Richard Dominic WIETFELDT, San Diego, CA (US)

(21) Appl. No.: 16/142,456

(22) Filed: Sep. 26, 2018

(51) Int. Cl. G06F 13/42; G06F 1/10

(52) U.S. Cl. CPC G06F 13/4282; G06F 2213/0016; G06F 1/10

(57) ABSTRACT

Systems, methods, and apparatus are described that enable a serial bus to be operated in one or more modes including a mode that encodes data in a clock signal. A method includes providing a clock signal that controls timing of transactions conducted over a serial bus, transmitting a first pair of data bytes at double data rate over a first wire of the serial bus in a first transaction, modulating the clock signal during the first transaction to provide a modulated clock signal that encodes at least one additional data byte, and transmitting the modulated clock signal over a second wire of the serial bus during the first transaction.

### TECHNICAL FIELD

The present disclosure relates generally to an interface between processing circuits and peripheral devices and, more particularly, to optimizing data communication throughput on a serial bus.

### BACKGROUND

Mobile communication devices may include a variety of components including circuit boards, integrated circuit (IC) devices and/or System-on-Chip (SoC) devices. The components may include processing devices, user interface components, storage and other peripheral components that communicate through a shared data communication bus, such as a serial bus or a parallel bus. General-purpose serial interfaces are known in the industry, including the Inter-Integrated Circuit (I2C or I²C) serial bus and its derivatives and alternatives. Certain serial interface standards and protocols are defined by the Mobile Industry Processor Interface (MIPI) Alliance, including the I3C, system power management interface (SPMI), and the Radio Frequency Front-End (RFFE) interface standards and protocols.

Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation. The protocols used on an I3C bus derive certain implementation aspects from the I2C protocol, while improving throughput and control of the serial bus. Original implementations of I2C supported data signaling rates of up to 100 kilobits per second (100 kbps) in standard-mode operation, with more recent standards supporting speeds of 400 kbps in fast-mode operation, and 1 megabit per second (Mbps) in fast-mode plus operation. I3C protocols can increase available bandwidth on the serial bus through higher transmitter clock rates, use of double data rate encoding, encoding data in signaling state of two or more wires, and through other encoding techniques.

In some examples, a serial bus may employ a multi-master protocol in which one or more devices can serve as a master and a slave for different messages transmitted on the serial bus. Data can be serialized and transmitted over two bidirectional wires, which may carry a data signal, which may be carried on a Serial Data Line (SDA or SDATA), and a clock signal, which may be carried on a Serial Clock Line (SCL or SCLK).

As applications have become more complex, demand for throughput over the serial bus can escalate and capacity may be strained or exceeded. There is an ongoing need for improved data encoding to support increased throughput over a serial bus without increasing system costs.

### SUMMARY

Certain aspects of the disclosure relate to systems, apparatus, methods and techniques that enable data to be encoded on a clock line of a serial bus in addition to data encoded in a signal transmitted over a data line of the serial bus.

In various aspects of the disclosure, a method includes providing a clock signal that controls timing of transactions conducted over a serial bus, transmitting a first pair of data bytes at double data rate over a first wire of the serial bus in a first transaction, modulating the clock signal during the first transaction to provide a modulated clock signal that encodes at least one additional data byte, and transmitting the modulated clock signal over a second wire of the serial bus during the first transaction.

In some aspects, the method includes transmitting a second pair of data bytes at double data rate signal over the first wire of the serial bus in a second transaction, and transmitting the clock signal over the second wire of the serial bus during the second transaction. The second transaction may be conducted in accordance with an I3C double data rate protocol. The method may include serializing the first pair of data bytes to obtain a serialized bit stream, and providing the serialized bit stream in a frame that has a format defined by the I3C double data rate protocol.

In one aspect, the method includes serializing the first pair of data bytes to obtain a serialized bit stream, inserting a parity bit after each data byte in the serialized bit stream, and providing preamble bits in the serialized bit stream to indicate location of parity bits in the serialized bit stream.

In one aspect, the method includes transmitting preamble bits in the first transaction to indicate that the modulated clock signal is being transmitted over the second wire of the serial bus. The preamble bits may be configured to indicate a type of modulation used to encode the at least one additional data byte.

In one aspect, the method includes transmitting a command code in the first transaction, the command code indicating that the modulated clock signal is being transmitted over the second wire of the serial bus.

In one aspect, the method includes serializing the first pair of data bytes to obtain a serialized bit stream, inserting a parity bit after each data byte in the serialized bit stream, and providing a command code in the serialized bit stream to indicate a format of a frame used to carry the serialized bit stream.

In various aspects of the disclosure, a data communication apparatus has a processor and a bus interface adapted to couple the apparatus to a serial bus. The processor may be configured to provide a clock signal that controls timing of transactions conducted over the serial bus, transmit a first pair of data bytes at double data rate over a first wire of the serial bus in a first transaction, modulate the clock signal during the first transaction to provide a modulated clock signal that encodes at least one additional data byte, and transmit the modulated clock signal over a second wire of the serial bus during the first transaction.

In various aspects of the disclosure, a data communication method includes recovering a clock signal from a first wire of a serial bus, decoding a first pair of data bytes from a double data rate signal received from a second wire of the serial bus during the first transaction, demodulating the clock signal during the first transaction to decode at least one additional data byte, and combining the first pair of data bytes with the at least one additional data byte to obtain first decoded data.

In one aspect, the method includes decoding a second pair of data bytes from the double data rate signal during a second transaction, and providing the second pair of data bytes as second decoded data. The second transaction may be conducted in accordance with an I3C double data rate protocol. The first pair of data bytes may be received in a frame that has a format defined by the I3C double data rate protocol.

In one aspect, the method includes receiving a parity bit after each data byte received from the double data rate signal. A first data byte of the first pair of data bytes may be received in its entirety from the double data rate signal before a second data byte of the first pair of data bytes is transmitted.

In one aspect, the method includes receiving preamble bits in the first transaction indicating that the modulated clock signal is being transmitted over the second wire of the serial bus. The preamble bits may be configured to indicate a type of modulation used to encode the at least one additional data byte.

In one aspect, the method includes receiving a command code in the first transaction, the command code indicating that the modulated clock signal is being transmitted over the second wire of the serial bus.

In various aspects of the disclosure, a data communication apparatus has a processor and a bus interface adapted to couple the apparatus to a serial bus. The processor may be configured to recover a clock signal from a first wire of the serial bus, decode a first pair of data bytes from a double data rate signal received from a second wire of the serial bus during the first transaction, demodulate the clock signal during the first transaction to decode at least one additional data byte, and combine the first pair of data bytes with the at least one additional data byte to obtain first decoded data.

### BRIEF DESCRIPTION OF THE DRAWINGS

FIG. 1 illustrates an apparatus employing a data link between IC devices that is selectively operated according to one of plurality of available standards.

FIG. 2 illustrates a communication interface in which a plurality of devices is connected using a serial bus.

FIG. 3 illustrates a system architecture for an apparatus employing a data link between IC devices.

FIG. 4 includes a timing diagram that illustrates signaling on a serial bus when the serial bus is operated in a single data rate (SDR) mode of operation defined by I3C specifications.

FIG. 5 is a timing diagram that illustrates an example of a transmission of a frame in an I3C SDR mode of operation.

FIG. 6 is a timing diagram that illustrates an example of a transmission of a frame in an I3C high data rate (HDR) mode of operation, where data is transmitted at double data rate (DDR).

FIG. 7 illustrates examples of signaling transmitted on the Data wire and Clock wire of a serial bus to initiate certain mode changes.

FIG. 8 illustrates two modulation modes that may be used to encode data in the clock signal transmitted over a serial bus in accordance with certain aspects disclosed herein.

FIG. 9 illustrates frames that may be used in conventional I3C high data rate, double data rate (HDR-DDR) mode and an enhanced I3C HDR-DDR mode provided in accordance with certain aspects disclosed herein.

FIG. 10 illustrates signaling that may be used to identify that an I3C HDR-DDR frame is to be transmitted in an enhanced HDR-DDR mode in accordance with certain aspects disclosed herein.

FIG. 11 illustrates an example of a vector-DDR decoding circuit that may be adapted for use in certain implementations disclosed herein.

FIG. 12 illustrates a protocol controller that may be adapted to operate as a bus master in accordance with certain aspects disclosed herein.

FIG. 13 illustrates a protocol controller that may be adapted to operate as a slave device in accordance with certain aspects disclosed herein.

FIG. 14 is a block diagram illustrating an example of an apparatus employing a processing circuit that may be adapted according to certain aspects disclosed herein.

FIG. 15 is a flowchart illustrating a process that may be performed at a transmitting device coupled to a serial bus in accordance with certain aspects disclosed herein.

FIG. 16 illustrates a hardware implementation for a transmitting apparatus adapted in accordance with certain aspects disclosed herein.

FIG. 17 is a flowchart illustrating a process that may be performed at a receiving device coupled to a serial bus in accordance with certain aspects disclosed herein.

FIG. 18 illustrates a hardware implementation for a receiving apparatus adapted in accordance with certain aspects disclosed herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of the invention will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

Overview

Devices that include multiple SoC and other IC devices often employ a serial bus to connect application processor or other host device with modems and other peripherals. The serial bus may be operated in accordance with specifications and protocols defined by a standards body. The serial bus may be operated in accordance with a standard or protocol such as the I2C, I3C, serial low-power inter-chip media bus (SLIMbus), system management bus (SMB), radio frequency front-end (RFFE) protocols that define timing relationships between signals and transmissions. Certain aspects disclosed herein relate to systems, apparatus, methods and techniques that enable a serial bus to be operated in one or more enhanced high data rate modes of operation, thereby increasing data throughput over the serial bus. For example, one mode encodes data in a clock signal that is also used to control transmissions of data encoded on a data line. One method includes providing a clock signal that controls timing of transactions conducted over a serial bus, transmitting a first pair of data bytes at double data rate over a first wire of the serial bus in a first transaction, modulating the clock signal during the first transaction to provide a modulated clock signal that encodes at least one additional data byte, and transmitting the modulated clock signal over a second wire of the serial bus during the first transaction.

In this disclosure, the terms data block and data frame may be interchangeably used when describing a unit of data transferred over a serial bus. In one example, the data block/data frame includes one 16-bit word when transmitted over the data wire of the serial bus when the serial bus is operated in accordance with an I3C HDR DDR protocol. In another example, the data block/data frame can include additional data encoded on the clock wire of the serial bus.

Example of an Apparatus with a Serial Data Link

According to certain aspects, a serial data link may be used to interconnect electronic devices that are subcomponents of an apparatus such as a cellular phone, a smart phone, a session initiation protocol (SIP) phone, a laptop, a notebook, a netbook, a smartbook, a personal digital assistant (PDA), a satellite radio, a global positioning system (GPS) device, a smart home device, intelligent lighting, a multimedia device, a video device, a digital audio player (e.g., MP3 player), a camera, a game console, an entertainment device, a vehicle component, a wearable computing device (e.g., a smart watch, a health or fitness tracker, eyewear, etc.), an appliance, a sensor, a security device, a vending machine, a smart meter, a drone, a multicopter, or any other similarly functioning device.

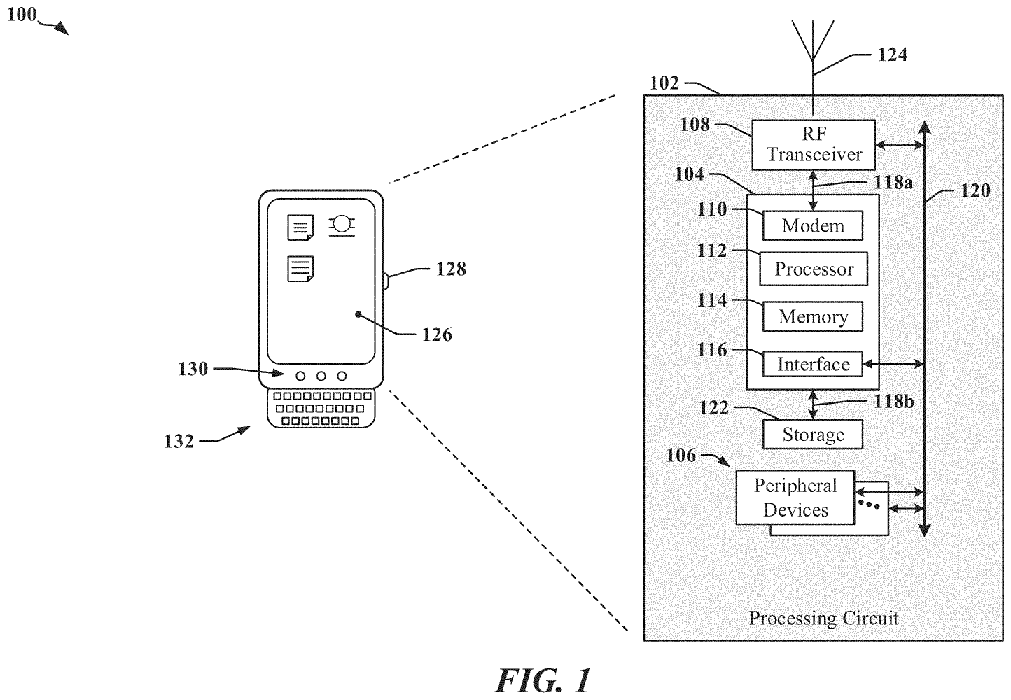

FIG. 1 illustrates an example of an apparatus 100 that may employ a data communication bus. The apparatus 100 may include an SoC a processing circuit 102 having multiple circuits or devices 104, 106 and/or 108, which may be implemented in one or more ASICs or in an SoC. In one example, the apparatus 100 may be a communication device and the processing circuit 102 may include a processing device provided in an ASIC 104, one or more peripheral devices 106, and a transceiver 108 that enables the apparatus to communicate through an antenna 124 with a radio access network, a core access network, the Internet and/or another network.

The ASIC 104 may have one or more processors 112, one or more modems 110, on-board memory 114, a bus interface circuit 116 and/or other logic circuits or functions. The processing circuit 102 may be controlled by an operating system that may provide an application programming interface (API) layer that enables the one or more processors 112 to execute software modules residing in the on-board memory 114 or other processor-readable storage 122 provided on the processing circuit 102. The software modules may include instructions and data stored in the on-board memory 114 or processor-readable storage 122. The ASIC 104 may access its on-board memory 114, the processor-readable storage 122, and/or storage external to the processing circuit 102. The on-board memory 114, the processor-readable storage 122 may include read-only memory (ROM) or random-access memory (RAM), electrically erasable programmable ROM (EEPROM), flash cards, or any memory device that can be used in processing systems and computing platforms. The processing circuit 102 may include, implement, or have access to a local database or other parameter storage that can maintain operational parameters and other information used to configure and operate the apparatus 100 and/or the processing circuit 102. The local database may be implemented using registers, a database module, flash memory, magnetic media, EEPROM, soft or hard disk, or the like. The processing circuit 102 may also be operably coupled to external devices such as the antenna 124, a display 126, operator controls, such as switches or buttons 128, 130 and/or an integrated or external keypad 132, among other components. A user interface module may be configured to operate with the display 126, external keypad 132, and other interface devices through a dedicated communication link or through one or more serial data interconnects.

The processing circuit 102 may provide one or more buses 118a, 118b, 120 that enable certain devices 104, 106, and/or 108 to communicate. In one example, the ASIC 104 may include a bus interface circuit 116 that includes a combination of circuits, counters, timers, control logic and other configurable circuits or modules. In one example, the bus interface circuit 116 may be configured to operate in accordance with communication specifications or protocols. The processing circuit 102 may include or control a power management function that configures and manages the operation of the apparatus 100.

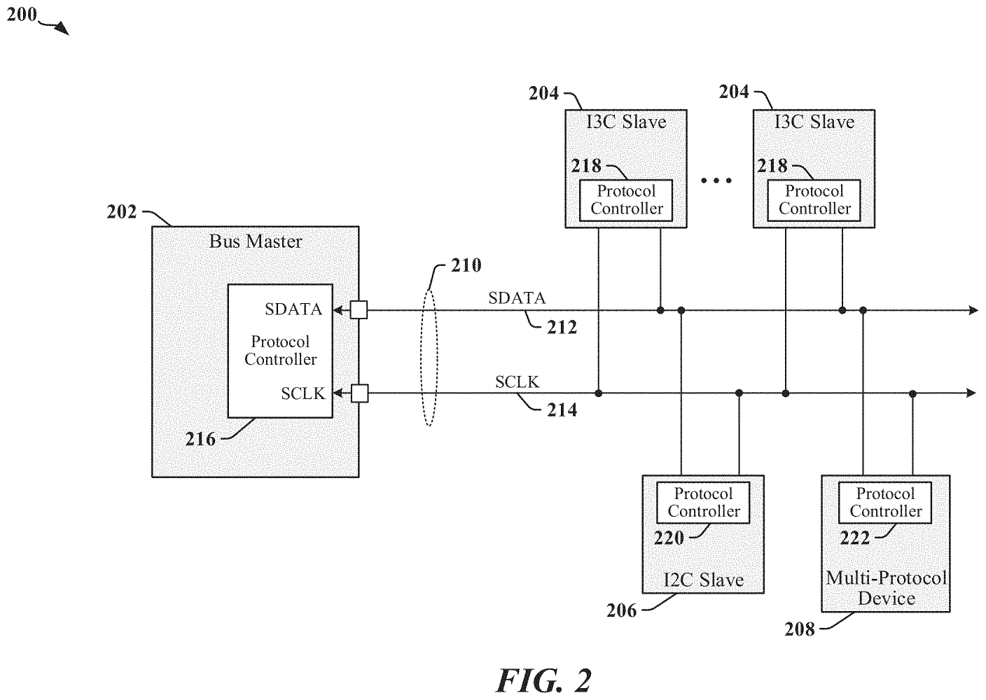

FIG. 2 illustrates a system 200 in which a variety of devices 202, 204, 206 and 208 are coupled through a serial bus 210. In one example, each of the devices 202, 204, 206 and 208 may be adapted or configured to communicate over the serial bus 210 in accordance with a common protocol, such as an I2C protocol. Multiple slave devices 204 may be configured for operation in accordance with I3C protocols. One or more legacy I2C slave devices 206 may be coupled to the serial bus 210 and may be restricted to participating in transactions conducted when the serial bus 210 is operated in accordance with the I2C protocol. A multi-protocol device 208 may be configurable for multiple protocols, including I2C, I3C and other protocols. In one example, the multi-protocol device 208 may be operable or configurable to serve as a bus master in certain transactions. Certain aspects of this disclosure relate to adaptation of devices 202, 204, 206 and/or 208 that can communicate in accordance with one or more I3C protocols.

Communication over the serial bus 210 may be controlled by a bus master device 202. In one mode of operation, the bus master device 202 may be configured to transmit a clock signal over an SCLK line 214 that provides timing information that permits data to be decoded from a data signal transmitted over an SDATA line 212. The devices 202, 204, 206 and 208 are typically coupled to the SDATA line 212 using bidirectional interface circuits. One or more protocols may be used to control the serial bus 210 such that more than one bus master device 202 may initiate and control certain transactions conducted over the serial bus 210, and both the SCLK line 214 and the SDATA line 212 may be bidirectional with respect to the bus master device 202 to enable the clock signal to be sourced from more than one bus master device 202.

The bus master device 202 may include a protocol controller 216 that can control operations of the serial bus 210 and that can manage exchange of control and data in transactions conducted in accordance with one or more protocols. The protocol controller 216 may include a processor and/or a finite state machine that controls operation of buffers, line drivers, line receivers, clock signal generation. In some instances, certain functions of the protocol controller 216 may be implemented using a general purpose processing circuit. Slave devices 204, 206 and 208 may include a protocol controller 218, 220, 222 that can monitor the serial bus 210 and respond to commands received from the bus master device 202. The protocol controllers 218, 220, 222 in the slave devices 204, 206 and 208 may manage slave-side exchanges of control and data in transactions conducted in accordance with one or more protocols. Each protocol controller 218, 220, 222 may include a processor and/or a finite state machine that controls operation of buffers, line drivers, line receivers, clock signal generation. In some instances, certain functions of the protocol controller 218, 220, 222 may be implemented using a general purpose processing circuit.

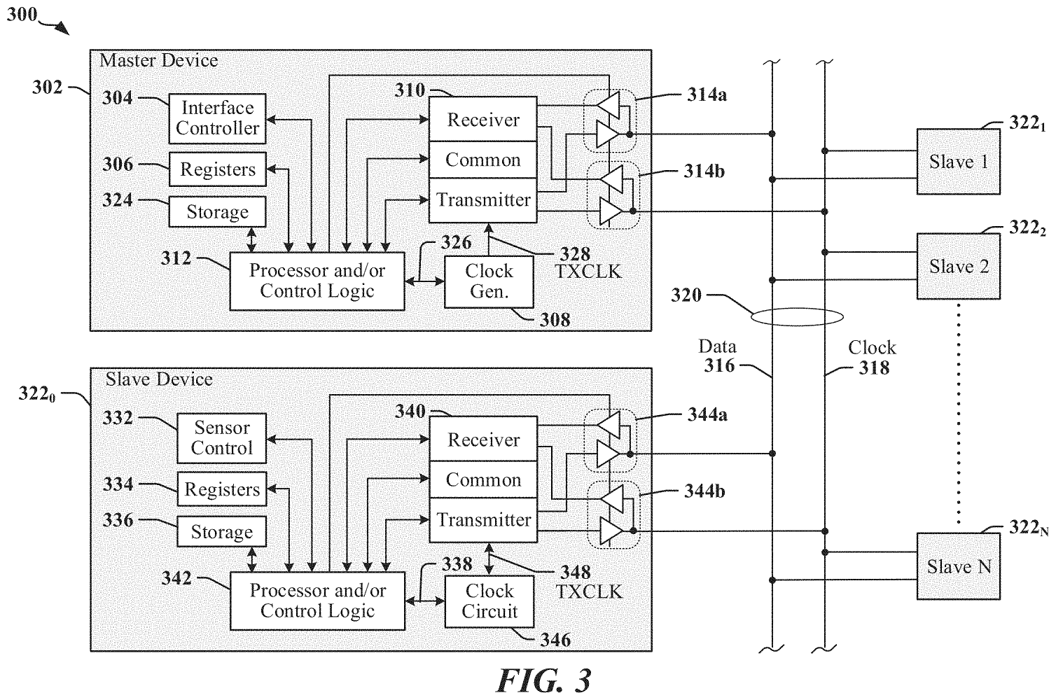

FIG. 3 illustrates certain aspects of an apparatus 300 that includes multiple devices 302, and 322₀-322_{N} coupled to a serial bus 320. The devices 302 and 322₀-322_{N} may be implemented in one or more semiconductor IC devices, such as an applications processor, SoC or ASIC. In various implementations the devices 302 and 322₀-322_{N} may include, support or operate as a modem, a signal processing device, a display driver, a camera, a user interface, a sensor, a sensor controller, a media player, a transceiver, and/or other such components or devices. In some examples, one or more of the slave devices 322₀-322_{N} may be used to control, manage or monitor a sensor device. Communications between devices 302 and 322₀-322_{N} over the serial bus 320 is controlled by a bus master device 302. Certain types of bus can support multiple bus master devices 302.

In one example, a bus master device 302 may include an interface controller 304 that may manage access to the serial bus, configure dynamic addresses for slave devices 322₀-322_{N} and/or generate a clock signal 328 to be transmitted on a clock line 318 of the serial bus 320. The bus master device 302 may include configuration registers 306 or other storage 324, and other control logic 312 configured to handle protocols and/or higher level functions. The control logic 312 may include a processing circuit such as a state machine, sequencer, signal processor or general-purpose processor. The bus master device 302 includes a transceiver 310 and line drivers/receivers 314a and 314b. The transceiver 310 may include receiver, transmitter and common circuits, where the common circuits may include timing, logic and storage circuits and/or devices. In one example, the transmitter encodes and transmits data based on timing in the clock signal 328 provided by a clock generation circuit 308. Other timing clocks 326 may be used by the control logic 312 and other functions, circuits or modules.

At least one device 322₀-322_{N} may be configured to operate as a slave device on the serial bus 320 and may include circuits and modules that support a display, an image sensor, and/or circuits and modules that control and communicate with one or more sensors that measure environmental conditions. In one example, a slave device 322₀ configured to operate as a slave device may provide a control function, module or circuit 332 that includes circuits and modules to support a display, an image sensor, and/or circuits and modules that control and communicate with one or more sensors that measure environmental conditions. The slave device 322₀ may include configuration registers 334 or other storage 336, control logic 342, a transceiver 340 and line drivers/receivers 344a and 344b. The control logic 342 may include a processing circuit such as a state machine, sequencer, signal processor or general-purpose processor. The transceiver 310 may include receiver, transmitter and common circuits, where the common circuits may include timing, logic and storage circuits and/or devices. In one example, the transmitter encodes and transmits data based on timing in a clock signal 348 provided by clock generation and/or recovery circuits 346. The clock signal 348 may be derived from a signal received from the clock line 318. Other timing clocks 338 may be used by the control logic 342 and other functions, circuits or modules.

The serial bus 320 may be operated in accordance with RFFE, I2C, I3C, SPMI, or other protocols. At least one device 302, 322₀-322_{N} may be configured to operate as a master device and a slave device on the serial bus 320. Two or more devices 302, 322₀-322_{N} may be configured to operate as a master device on the serial bus 320.

In some implementations, the serial bus 320 may be operated in accordance with an I3C protocol. Devices that communicate using the I3C protocol can coexist on the same serial bus 320 with devices that communicate using I2C protocols. The I3C protocols may support different communication modes, including an SDR mode that is compatible with I2C protocols. HDR modes may provide a data transfer rate between 6 megabits per second (Mbps) and 16 Mbps, and some HDR modes may be provide higher data transfer rates. I2C protocols may conform to de facto I2C standards providing for data rates that may range between 100 kilobits per second (kbps) and 3.2 Mbps. I2C and I3C protocols may define electrical and timing aspects for signals transmitted on the 2-wire serial bus 320, in addition to data formats and aspects of bus control. In some aspects, the I2C and I3C protocols may define direct current (DC) characteristics affecting certain signal levels associated with the serial bus 320, and/or alternating current (AC) characteristics affecting certain timing aspects of signals transmitted on the serial bus 320. In some examples, a 2-wire serial bus 320 transmits data on a data line 316 and a clock signal on the clock line 318. In some instances, data may be encoded in the signaling state, or transitions in signaling state of the data line 316 and the clock line 318.

Data Transfers Over an I3C Serial Bus

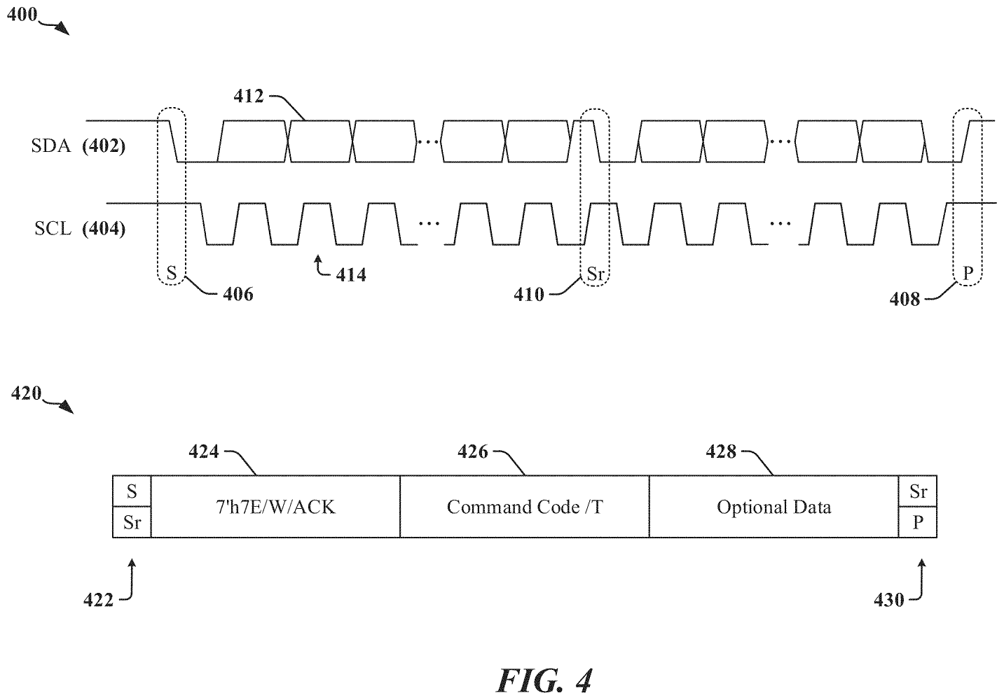

FIG. 4 includes a timing diagram 400 that illustrates signaling on a serial bus when the serial bus is operated in an SDR mode of operation defined by I3C specifications. Data transmitted on a first wire (the Data wire 402) of the serial bus may be captured using a clock signal transmitted on a second wire (the Clock wire 404) of the serial bus. During data transmission, the signaling state 412 of the Data wire 402 is expected to remain constant for the duration of the pulses 414 when the Clock wire 404 is at a high voltage level. Transitions on the Data wire 402 when the Clock wire 404 is at the high voltage level indicate a START condition 406, a STOP condition 408 or a repeated START 410.

On an I3C serial bus, a START condition 406 is defined to permit the current bus master to signal that data is to be transmitted. The START condition 406 occurs when the Data wire 402 transitions from high to low while the Clock wire 404 is high. The bus master may signal completion and/or termination of a transmission using a STOP condition 408. The STOP condition 408 is indicated when the Data wire 402 transitions from low to high while the Clock wire 404 is high. A repeated START 410 may be transmitted by a bus master that wishes to initiate a second transmission upon completion of a first transmission. The repeated START 410 is transmitted instead of, and has the significance of a STOP condition 408 followed immediately by a START condition 406. The repeated START 410 occurs when the Data wire 402 transitions from high to low while the Clock wire 404 is high.

The bus master may transmit an initiator 422 that may be a START condition 406 or a repeated START 410 prior to transmitting an address of a slave, a command, and/or data. FIG. 4 illustrates a command code transmission 420 by the bus master. The initiator 422 may be followed in transmission by a predefined command 424 indicating that a command code 426 is to follow. The command code 426 may, for example, cause the serial bus to transition to a desired mode of operation. In some instances, data 428 may be transmitted. The command code transmission 420 may be followed by a terminator 430 that may be a STOP condition 408 or a repeated START 410.

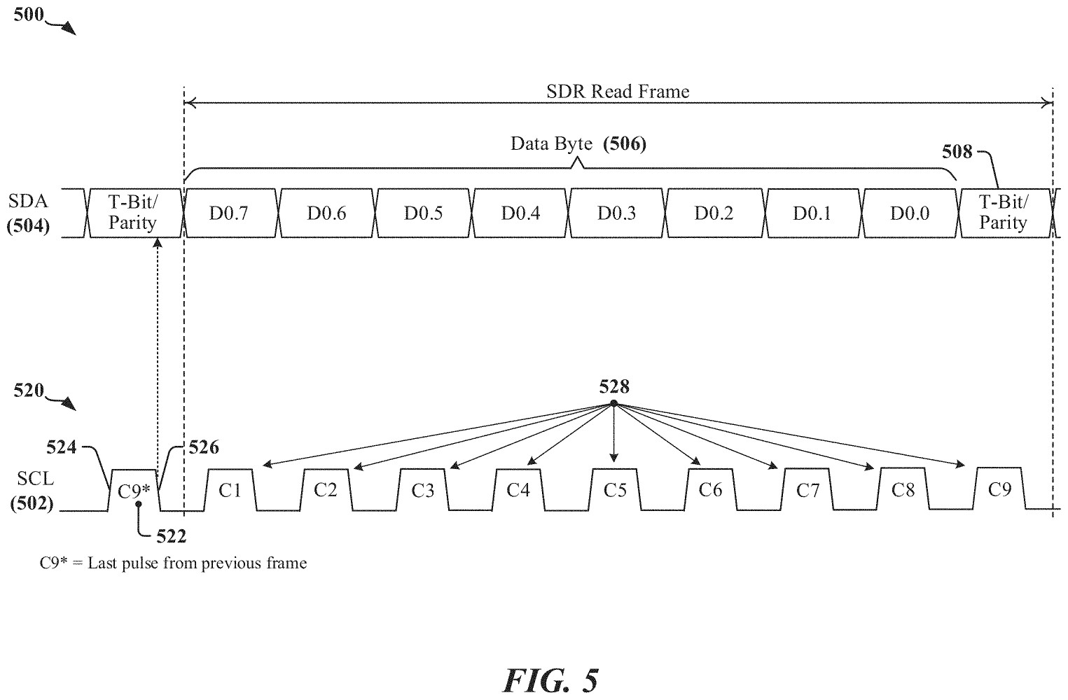

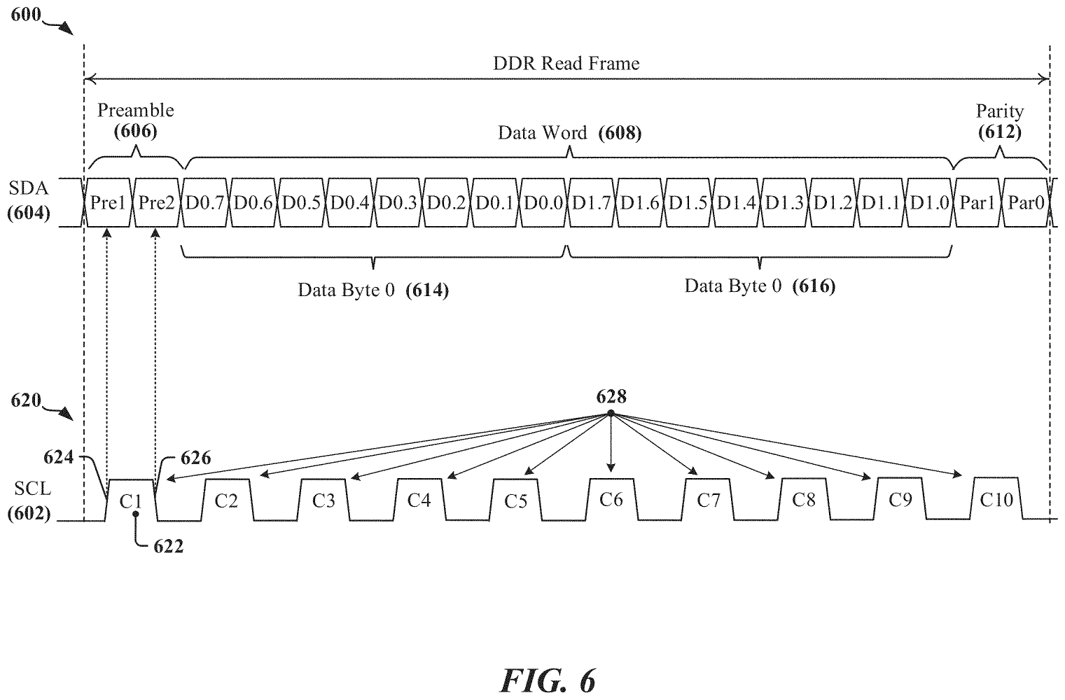

FIGS. 5 and 6 are timing diagrams that illustrate frames 500, 600 transmitted on a serial bus when a bus master device is reading from a slave device. The serial bus has a clock wire (SCL 502, 602) and a Data wire (SDA 504, 604). A clock signal 520, 620 transmitted on SCL 502, 602 provides timing may be usable when the serial bus is operated in an I3C SDR mode and in an I3C HDR-DDR mode. The clock signal includes pulses 522, 528, 622, 628 that are defined by a rising edge 524, 624 and a falling edge 526, 626. A bus master device transmits the clock signal on the SCL 502, 602 regardless of the direction of flow of data over the serial bus.

FIG. 5 illustrates a frame 500 transmitted while the serial bus is operated in the I3C SDR mode. A single byte of data 506 is transmitted in each frame 500. The data signal transmitted on SDA 504 is expected to be stable for the duration of the high state of the pulses 528 in the clock signal 520 and, in one example, the state of SDA 504 is sampled on the falling edges of the pulses 528 in the clock signal 520. Each byte of data 506 is followed by a bit 508 that can serve as a parity bit or a transition bit (T-Bit).

FIG. 6 illustrates a frame 600 transmitted while the serial bus is operated in the I3C HDR-DDR mode. In the I3C HDR-DDR mode, data is transferred at both the rising edge 624 and the falling edge 626 of a pulse 622 in the clock signal 620. A receiver samples or captures one bit of data on SDA 604 at each edge of the pulses 628 in the clock signal 620. A 2-byte data word 608 is transmitted in each frame 600 in the I3C HDR-DDR mode. A data word 608 generally includes 16 payload bits, organized as two 8-bit bytes 614, 616 and the data word 608 is preceded by a two-bit preamble 606 and followed by two parity bits 612. The 20 bits in the frame 600 can be transferred on the edges of 10 clock pulses. The integrity of the transmission may be protected by the transmission of the parity bits 612.

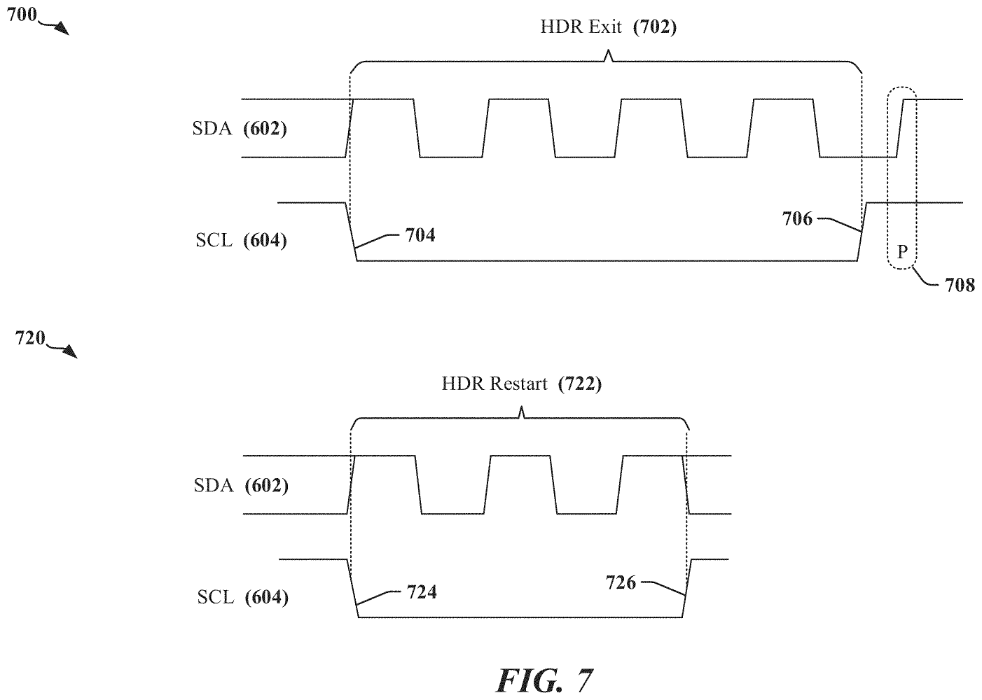

An I3C bus may be switched between I3C SDR and I3C DDR modes. FIG. 7 illustrates examples of signaling 700, 720 transmitted on SDA 604 and SCL 602 to initiate certain mode changes. The signaling 700, 720 is defined by I3C protocols for use in initiating restart, exit and/or break from I3C HDR modes of communication.

The first signaling 700 serves an HDR Exit 702 that may be used to cause an HDR break or exit. The HDR Exit 702 commences with a falling edge 704 on SCL 602 and ends with a rising edge 706 on SCL 602. While SCL 602 is in low signaling state, four pulses are transmitted on SDA 604. I2C devices ignore SDA 604 when no pulses are provided on SCL 602. A stop condition 708 may be transmitted to cause slave devices to reset their respective bus interfaces.

The second signaling 720 is an HDR Restart 722 that may be used to indicate a continuation of HDR transmission. The HDR Restart 722 commences with a falling edge 704 on SCL 602 and ends with a rising edge 706 on SCL 602, which confirms further HDR transmission. While SCL 602 is in low signaling state, three pulses are transmitted on SDA 604. I2C devices ignore SDA 604 when no pulses are provided on SCL 602.

I3C protocols also defines an HDR-Ternary mode of communication in which data is encoded in signals transmitted on the SDATA line 212 and the SCLK line 214 (see FIG. 2). In one implementation, data is transcoded from binary bits to ternary digits, where each ternary digit is used to select a next signaling state of the two wires of the serial bus 210. Four possible signaling states are defined for the serial bus 210, and the ternary digit is used to select one of three signaling states for a next transmission interval that is different from the signaling state current transmission interval, thereby ensuring a transition on at least one of the two wires of the serial bus 210. That is, signaling state of one or both of the SDATA line 212 and the SCLK line 214 changes at the boundary between each pair of consecutive transmission intervals.

Devices 202, 204, 208 that support I3C HDR-Ternary mode may include a complex bus interface to implement HDR-Ternary data encoding. For example, complex clock recovery circuits may be required to monitor the SDATA line 212 and the SCLK line 214 and to accommodate timing differences between signals transmitted on the SDATA line 212 and the SCLK line 214. Data encoding is state based, requiring knowledge of past states and, in some instances, a transmission error can affect decoding of subsequently transmitted signaling states. Additionally, the interleaving of data bits in the two bytes encoded in an HDR-Ternary frame can result in both bytes being dropped when a parity error is detected.

Coexistence issues can also increase protocol and circuit complexity to avoid transmission of signaling in I3C HDR-Ternary mode that can be interpreted as I2C control signaling, for example. The HDR-Ternary mode may also lack feature uniformity with regard to other I3C HDR modes. HDR-Ternary mode employs a 16-bit word frame that eliminates certain signaling bits transmitted in other HDR modes, including preamble bits transmitted at the commencement of an HDR-DDR frame. HDR-Ternary frame size is different from the frame size used in HDR-DDR. An HDR-DDR frame carrying two bytes of data may be transmitted in 10 clock cycles (see FIG. 6), whereas the length of a Ternary frame carrying two bytes of data is transmitted in 6 clock cycles. The resultant asymmetry of frame size can cause system design issues, including issues related to buffer space allocation. The HDR-Ternary mode can be 160% faster than the HDR-DDR mode.

Encoding Data by Modulating the Clock Signal

According to certain aspects, the I3C HDR-DDR mode may be adapted to improve data through rate of a serial bus 210 by encoding data on the clock signal transmitted over the SCLK line 214. The clock signal may be encoded using pulse-width modulation (PWM), phase modulation, pulse amplitude modulation (PAM), pulse position modulation, or the like. The frame duration for HDR-DDR is preserved at 10 clock cycles, with three bytes of data transmitted per frame. An encoding gain of 150% may be achieved over conventional I3C HDR-DDR mode. The encoding gain of 150% compares favorably with the HDR-Ternary encoding gain of 160% when the reduced complexity of implementation and other benefits are taken into consideration.

According to certain aspects disclosed herein, a heterogenous encoding scheme can be implemented such that the SDATA line 212 line carries two data bits per clock cycle while another bit is encoded in the SCLK line 214 for each clock cycle. Data is encoded on the SDATA line 212 in accordance with I3C protocols. In some implementations, bit positions of parity within a frame may be adjusted to reduce bus latency, improve handling efficiency, increase robustness under error conditions and/or reduce circuit complexity in the bus interface. The mode of encoding the clock signal may be configurable, and a bus master device 202 may select from PWM, phase modulation, PAM, pulse position modulation, or another type of modulation supported by devices 202, 204, 208 involved in a transaction.

According to certain aspects, the slots in the frame reserved for preamble bits transmitted in conventional HDR-DDR can be preserved in frames transmitted with modulated clock signals. In some instances, the pulse in the clock signal that is transmitted concurrently with the preamble bits is unmodulated and/or may be used for hardware synchronization that enables the receiver to recover clock and data timing from the encoded clock signal.

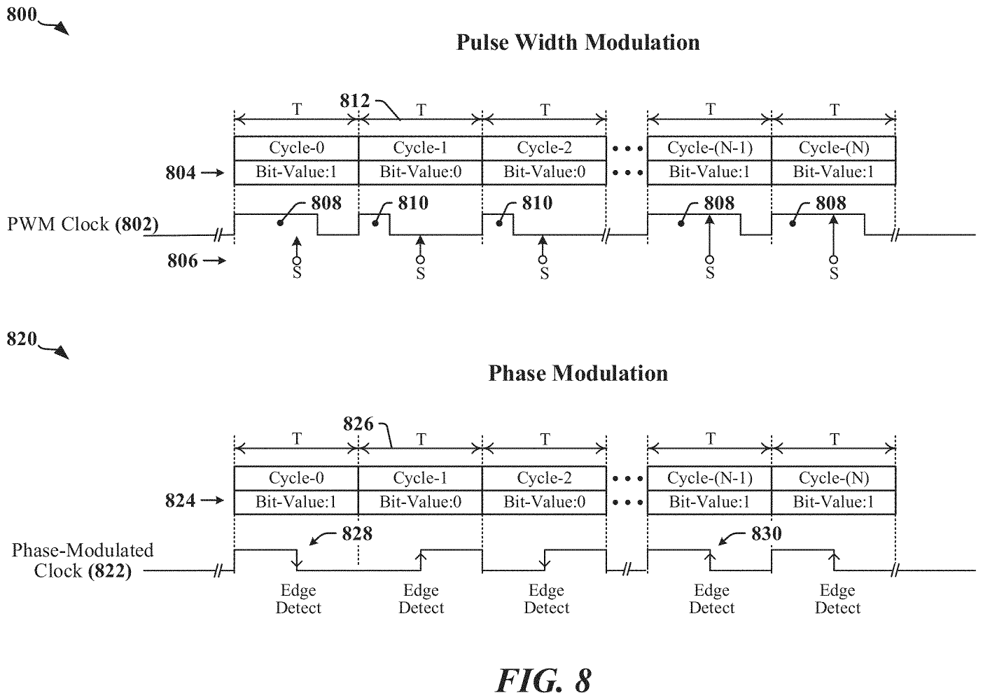

FIG. 8 illustrates two modulation modes 800, 820 that may be used to encode data in the clock signal of a serial bus operated in accordance with certain aspects disclosed herein. The first modulation mode 800 employs pulse-width modulation (PWM) in which data is encoded in the width of pulses in a PWM clock signal 802 transmitted over the SCLK line 214 (see FIG. 2). In the illustrated example, pulses 808, 810 are provided in the PWM clock signal 802 by driving the PWM clock signal 802 to a high voltage state for a duration of time referred to herein as the pulse width, before returning the PWM clock signal 802 to the low state. The values of a bits of a data payload 804 are encoded in the width of pulses 808, 810. In the illustrated example, a zero-value bit is represented as a short pulse 810, while a bit having the value ‘1’ is represented as a long pulse 808. In one example, the short pulse 810 may be defined as a pulse that is less than half the transmission clock period 812, while the long pulse 808 may be defined as a pulse that is greater than half the transmission clock period 812. Accordingly, a receiver may capture data at sampling points 806 in the middle of each transmission clock period 812, as identified by the ideal sampling points 806.

The second modulation mode 820 employs phase modulation in which data is encoded in the direction of transitions within pulses of a phase-modulated clock signal 822 transmitted over a wire. In the illustrated example, values of bits of a data payload 824 are encoded in the transitions that occur at, or near the center point of each transmission clock period 826. A zero-bit value is encoded as a low-to-high transition 830, while a bit having the value ‘1’ is represented as a high-to-low transition 828.

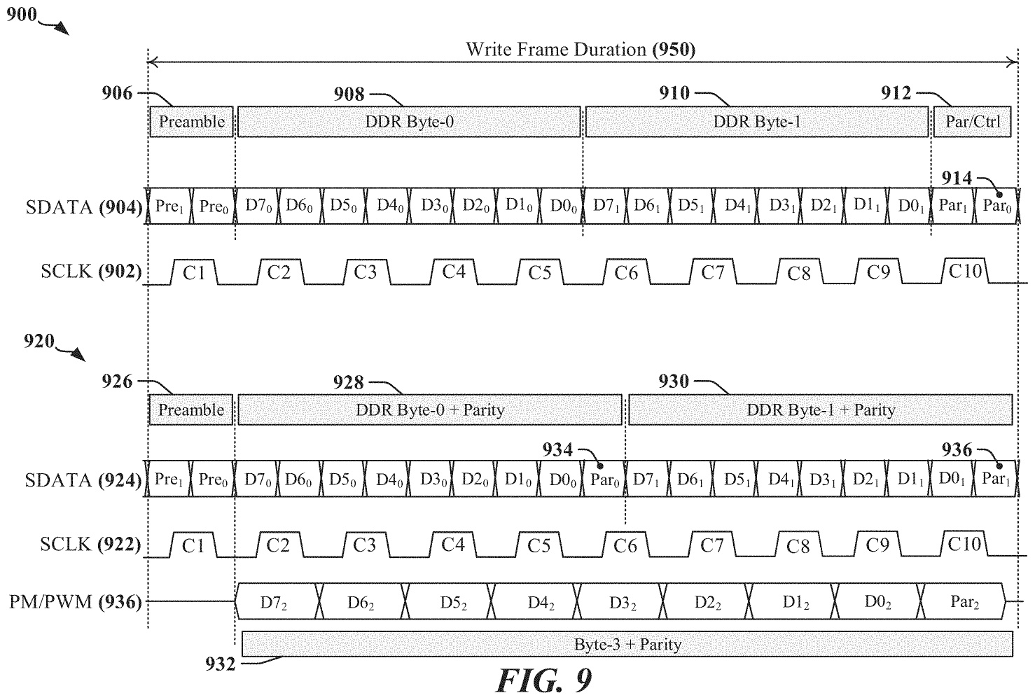

FIG. 9 illustrates frames 900, 920 that may be used in conventional I3C HDR-DDR mode and an enhanced I3C HDR-DDR mode, respectively. In a conventional I3C HDR-DDR frame 900, a two bit preamble 906 precedes two data bytes 908, 910 followed by parity 912. The bits in the preamble 906, data bytes 908, 910 and parity 912 are transmitted over the SDATA line 904 on rising and falling edges of the clock signal transmitted on the SCLK line 902. The frame duration 950 corresponds to 10 cycles of the clock signal. Each of the two parity bits transmitted as parity 912 corresponds to one of the data bytes 908, 910. The last bit 914 transmitted in the frame is the parity bit for the first-transmitted data byte 908. Certain aspects disclosed herein address the increased latency associated with the first-transmitted data byte 908 experienced when the first-transmitted data byte 908 cannot be processed until parity is calculated and checked.

According to certain aspects disclosed herein, an I3C HDR-DDR frame 920 transmitted in an enhanced HDR-DDR mode may effectively carry three bytes 928, 930, 932. On the SDATA line 924, a two bit preamble 906 is transmitted followed by two data bytes 908, 910, which each include respective parity bits 934, 936. In some implementations, the bits transmitted over the SDATA line 924 may be formatted in the same manner as illustrated for a conventional I3C HDR-DDR frame 900. A third data byte 932 may be encoded in the clock signal transmitted over the SCLK line 922. In one example, the order of transmission of the third data byte 932 may be similar to the frame structure used for SDR communication (compare with FIG. 5) when data is encoded in a phase-modulated or PWM clock signal. The bits in the preamble 926 and data bytes 928, 930 transmitted over the SDATA line 904 are timed by rising and falling edges of the clock signal transmitted on the SCLK line 902. The frame duration 950 corresponds to 10 cycles of the clock signal. The embedding of parity information with each of the associated data bytes 928, 930, 932 can reduce latency by permitting parity calculations and checking to be performed upon receiving the last bit of the associated data byte 928, 930, 932.

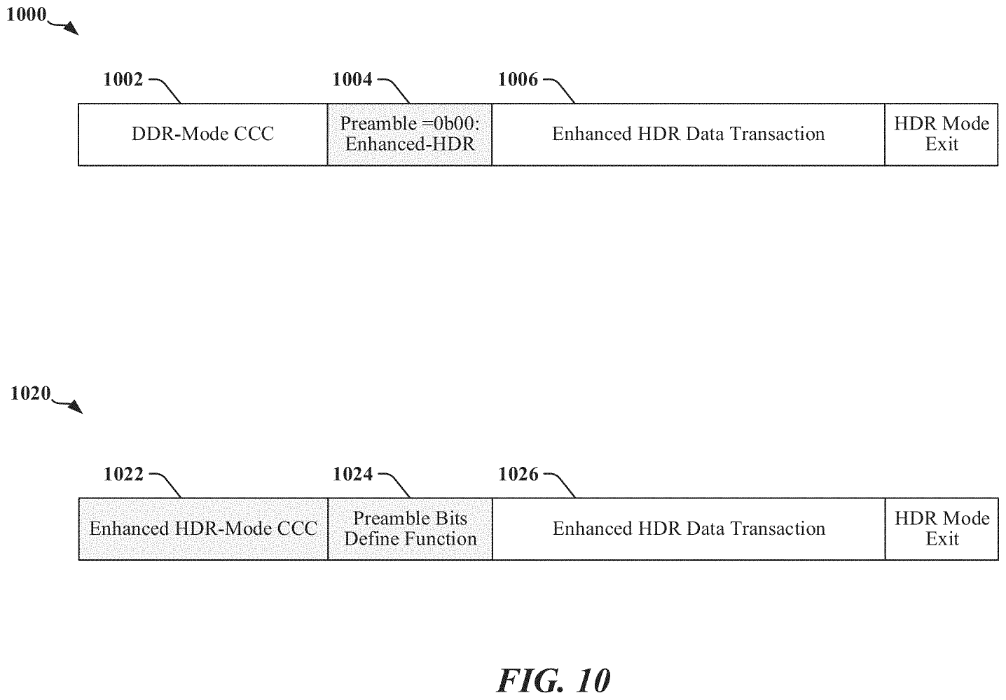

FIG. 10 illustrates signaling 1000, 1020 that may be used to indicate that an I3C HDR-DDR frame 920 is to be transmitted in an enhanced HDR-DDR mode. In some instances, the enhanced HDR-DDR mode frames 1006 may be used when a data byte is encoded in the clock signal. In some instances, the enhanced HDR-DDR mode frames 1006 may be used when parity is to be embedded with the data byte transmitted over the SDATA line 924. In other instances, the enhanced HDR-DDR mode frames 1006 may be used when a data byte is encoded in the clock signal and parity is to be embedded with the data byte transmitted over the SDATA line 924.

In a first example, signaling 1000 includes a conventional HDR-DDR mode command code 1002 with preamble bits 1004 that identify the payload as including one or more enhanced HDR-DDR mode frames 1006. In one example, both preamble bits 1004 may be set to zero values to indicate that HDR-DDR mode frames 1006 are to be transmitted.

In a second example, signaling 1020 includes an enhanced HDR-DDR command code 1022 that identifies the payload as including one or more enhanced HDR-DDR mode frames 1026. The preamble bits 1024 may be used to indicate a specific configuration of the enhanced HDR-DDR mode frames 1026. In one example, the preamble bits 1024 may indicate the location of parity bits. In another example, the preamble bits 1024 may indicate the type of encoding used on the clock signal. In various examples, the meaning of the preamble bits 1024 may be defined in a configuration register.

In some implementations, one or more devices 202, 204, 208 may be adapted to decode data from the SDATA line 212 using vector-DDR decoding techniques. Vector-DDR decoding techniques can reduce bit error rates by providing reliable capture of encoded data at higher clock rates.

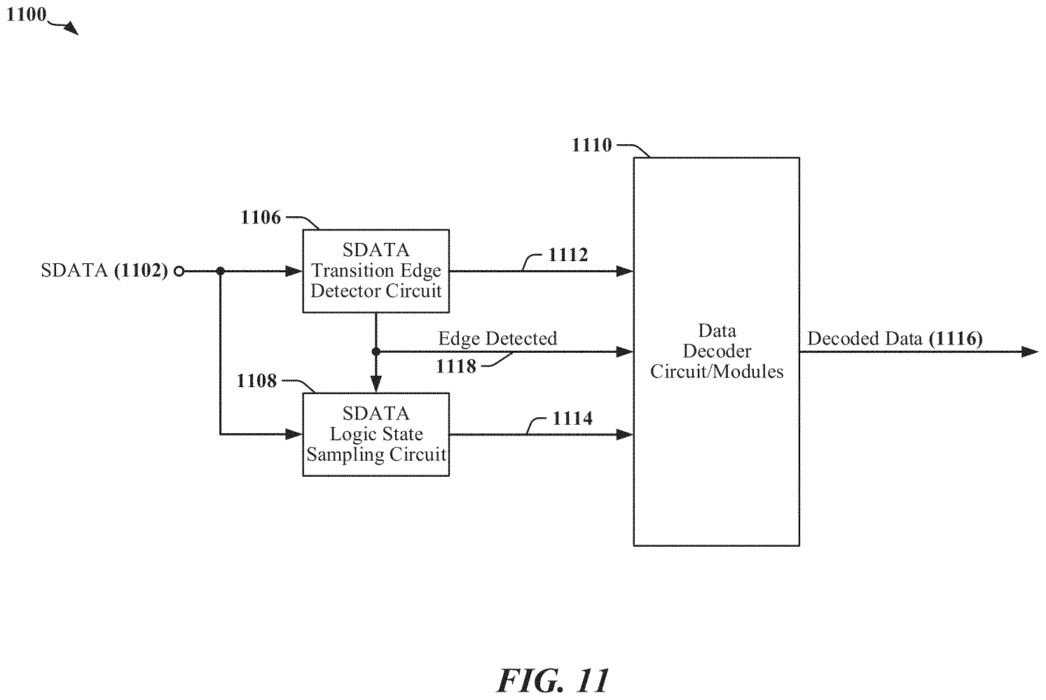

FIG. 11 illustrates an example of a vector-DDR decoding circuit 1100. Vector-DDR decoding may provide circuits and logic with resilience to tight timing budgets that may arise when the clock signal is used to encode data. The vector-DDR decoding circuit 1100 includes an SDATA Transition-Edge detector circuit 1106 coupled to SDATA 1102. When enabled and/or active the SDATA Transition-Edge detector circuit 1106 detects transitions on SDATA 1102 during the SDATA sampling window.

The vector-DDR decoding circuit 1100 further includes an SDATA Logic State sampling circuit 1108 which samples the logic state of SDATA 1102 during the sampling window when enabled and/or active. In certain examples, the SDATA Logic State sampling circuit 1108 may respond to an edge detection signal 1118 provided by the SDATA Transition-Edge detector circuit 1106. The edge detection signal 1118 may indicate that no edge has been detected in the current pair of consecutive bits and the SDATA Logic State sampling circuit 1108 may respond by sampling the signaling state of SDATA 1102. The edge detection signal 1118 may indicate that an edge has been detected in the current pair of consecutive bits and, in some examples, the SDATA Logic State sampling circuit 1108 may respond by suppressing sampling of SDATA 1102.

The vector-DDR decoding circuit 1100 further includes a data decoder circuit 1110 that decodes data from signals 1112, 1114 received from the SDATA Transition-Edge detector circuit 1106 and the SDATA Logic State sampling circuit 1108, respectively. In various examples, the data decoder circuit 1110 determines whether the SDATA Transition-Edge detector circuit 1106 has detected an edge during the sampling window. For example, the data decoder circuit 1110 may respond to an edge detection signal 1118 provided by the SDATA Transition-Edge detector circuit 1106 indicating whether a transition has been detected between the bits of the current pair of consecutive bits received from SDATA 1102. When a transition has occurred, the data decoder circuit 1110 may use the direction of transition in the edge (as indicated by the SDATA Transition-Edge detector circuit 1106) to decode the two bits of data transmitted during the current clock cycle. When no transition has occurred, the data decoder circuit 1110 may use the logic state of SDATA 1102 as indicated by the SDATA Logic State sampling circuit 1108 to define the two bits of data transmitted during the current clock cycle. The data decoder circuit 1110 provides a stream of decoded bits 1116 for deserialization.

In some implementations, the vector-DDR decoding circuit 1100 may account for line inversion mode of SDATA 1102. The line inversion mode of SDATA 1102 may determine whether data bits are transmitted in like-state on SDATA 1102, or in an inverted state on SDATA 1102. For example, like-state may be in use when a high voltage state on SDATA 1102 represents a logic 1 transmitted bit-value while a low voltage state on SDATA 1102 represents a logic 0 transmitted bit-value. In other examples, inverted state may be in use when a high voltage state on SDATA 1102 represents a logic 0 transmitted bit-value while a low voltage state on SDATA 1102 represents a logic 1 transmitted bit-value. According to certain aspects, the vector-DDR decoding circuit 1100 may be configured with information indicating the line inversion mode of SDATA 1102.

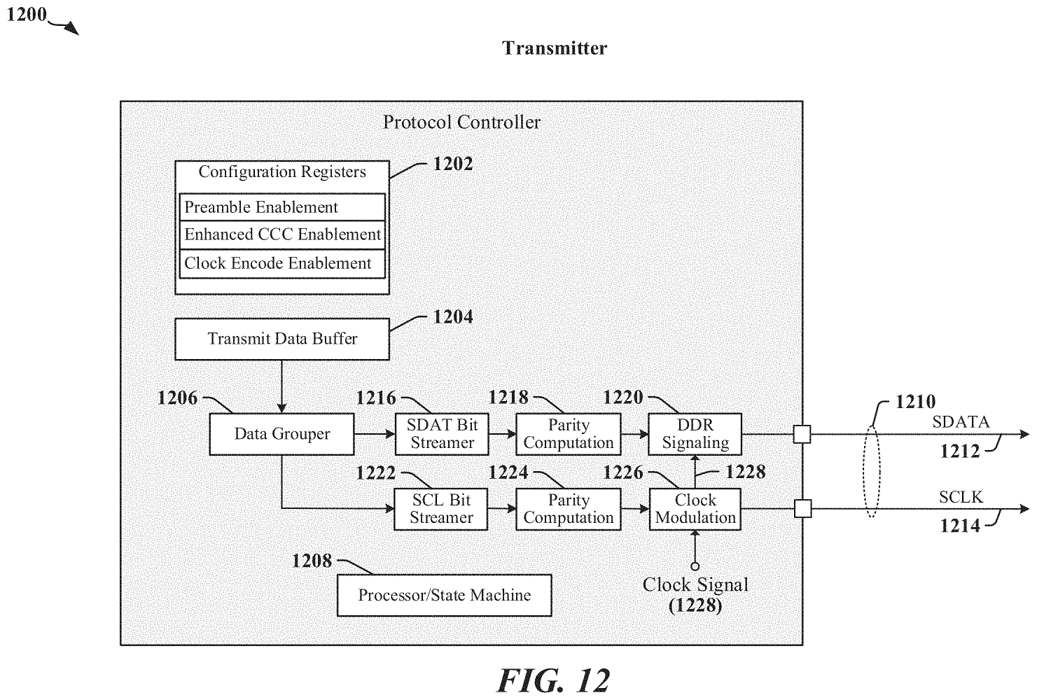

FIG. 12 illustrates a protocol controller 1200 that may be adapted to operate as a bus master in accordance with certain aspects disclosed herein. In some instances, the protocol controller 1200 may be provided in a slave device. In the illustrated example, the protocol controller 1200 may control transmissions over a serial bus 1210. The protocol controller 1200 may be coupled to the serial bus 1210 and may be configurable to communicate over the bus in accordance with one or more protocols. The protocol controller 1200 may include or have access to configuration registers 1202 that define modes of operation and/or aspects of protocols supported by the protocol controller 1200. In one example, the protocol controller 1200 may be adapted to operate the serial bus 1210 in accordance with an enhanced I3C HDR-DDR protocol.

The configuration registers 1202 may define a unique command code that initiates communication in accordance with an enhanced I3C HDR-DDR protocol. In some instances, the configuration registers 1202 may indicate that a combination of a conventional command code and coded preamble bits used to initiate a transaction conducted according to an enhanced I3C HDR-DDR protocol. The preamble bits may alternatively or additionally be used to indicate a type of frame used when the serial bus 1210 is operated according to the enhanced I3C HDR-DDR protocol. The configuration registers 1202 may define preamble bits to be transmitted to indicate a type of modulation used to encode data in a clock signal transmitted over the SCLK line 1214 while DDR data is transmitted over the SDATA line 1212. The configuration registers 1202 may define preamble bits to be transmitted to indicate position of parity bits in a frame transmitted over the SDATA line 1212. The configuration registers 1202 may configure the protocol controller 1200 for encoding data in the clock signal transmitted over the SCLK line 1214.

The protocol controller 1200 may include a processor 1208, processing circuit and/or a finite state machine that manages the various interface circuits in the protocol controller 1200. The processor 1208 may determine that data is available in a transmit buffer 1204 for transmission over the serial bus 1210. When configured for enhanced HDR-DDR modes of communication, the processor 1208 may provide data to a data grouping circuit or module 1206 of the protocol controller 1200. The data grouping circuit or module 1206 may split the data into 2-byte words for transmission over the SDATA line 1212 with a third byte that is to be encoded in the clock signal for transmission over the SCLK line 1214.

Data to be transmitted over the SDATA line 1212 is provided to a parallel-to-serial converter or other bit streamer 1216 that orders the bits for transmission over the SDATA line 1212. A parity generator 1218 may compute parity bits that are added to the bit stream output by the bit streamer 1216 to be transmitted in a DDR signal that is generated using a clock signal 1228.

Data to be transmitted over the SCLK line 1214 is provided to a parallel-to-serial converter or other bit streamer 1222 that orders the bits for transmission over the SCLK line 1214. A parity generator 1224 may compute parity bits that are added to the bit stream output by the bit streamer 1222 to be used for modulating the clock signal 1228 using a clock modulation circuit 1226 or other encoding circuit.

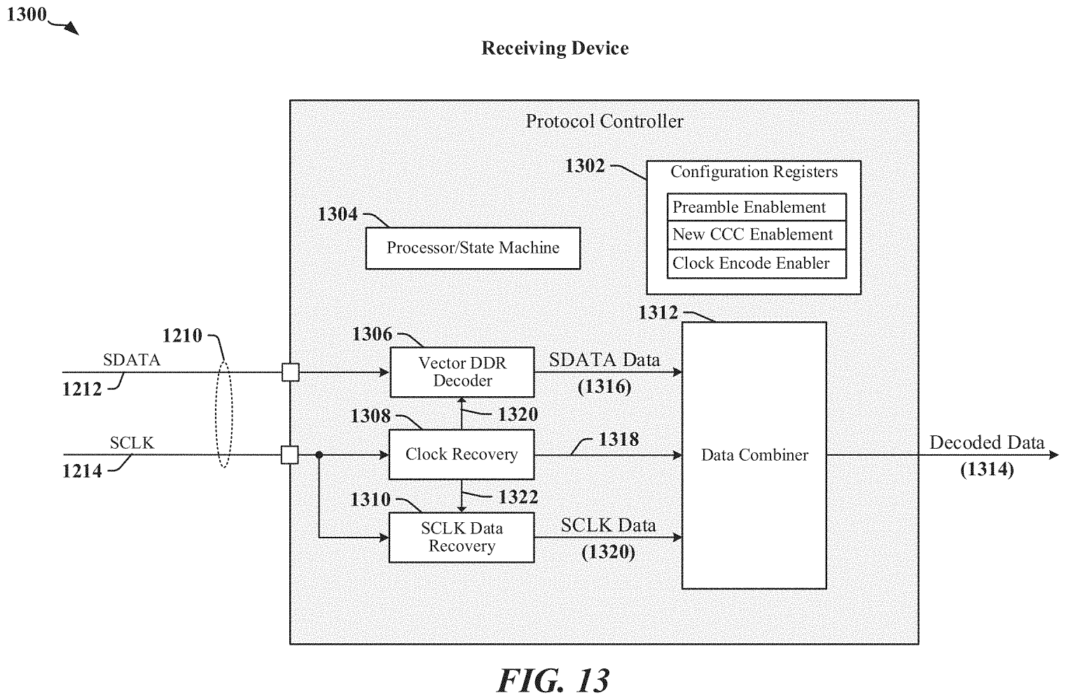

FIG. 13 illustrates a protocol controller 1300 that may be adapted to operate as a slave device in accordance with certain aspects disclosed herein. In some instances, the protocol controller 1300 may be provided in a bus master. In the illustrated example, the protocol controller 1300 may be coupled to the serial bus 1210 and may be configurable to communicate over the bus in accordance with one or more protocols. The protocol controller 1300 may monitor transmissions on the serial bus 1210 and receive data in response to commands. The protocol controller 1300 may include or have access to configuration registers 1302 that define modes of operation and/or aspects of protocols supported by the protocol controller 1300. In one example, the protocol controller 1300 may be adapted to operate in accordance with an enhanced I3C HDR-DDR protocol.

The configuration registers 1302 may define a unique command code that initiates communication in accordance with an enhanced I3C HDR-DDR protocol. In some instances, the configuration registers 1302 may indicate that a combination of a conventional command code and coded preamble bits indicate that transaction is to be conducted according to an enhanced I3C HDR-DDR protocol. The preamble bits may alternatively or additionally indicate a type of frame used and that the serial bus 1210 is being operated according to the enhanced I3C HDR-DDR protocol. The configuration registers 1302 may define preamble bits that indicate a type of modulation used to encode data in a clock signal transmitted over the SCLK line 1214 while DDR data is being received from the SDATA line 1212. The configuration registers 1302 may define preamble bits that indicate position of parity bits in a frame transmitted over the SDATA line 1212. The configuration registers 1302 may configure the protocol controller 1300 for decoding data from the clock signal received from the SCLK line 1214.

The protocol controller 1300 may include a processor 1304, processing circuit and/or a finite state machine that manages the various interface circuits in the protocol controller 1300. Data received from the SDATA line 1212 when the serial bus 1210 is being operated according to the enhanced I3C HDR-DDR protocol may be decoded using a vector DDR decoder 1306. The vector DDR decoder 1306 receives a clock signal extracted from the SCLK line 1214 by a clock recovery circuit 1308. The clock recovery circuit 1308 also provides a timing signal 1322 to an SCLK data recovery circuit 1310 that may be enabled when the clock signal received from the SCLK line 1214 is modulated and/or encoded with data. The vector DDR decoder 1306 provides decoded SDATA data 1316 to a data combiner 1312 and the SCLK data recovery circuit 1310 provides decoded SCLK data 1320 to the data combiner 1312. In one example, the decoded SDATA data 1316 includes two bytes of data for each byte of data in the decoded SCLK data 1320. The data combiner 1312 uses timing information 1318 received from the clock recovery circuit 1308 to provide decoded output data 1314 after recombining the decoded SCLK data 1320 and the decoded SDATA data 1316.

Examples of Processing Circuits and Methods

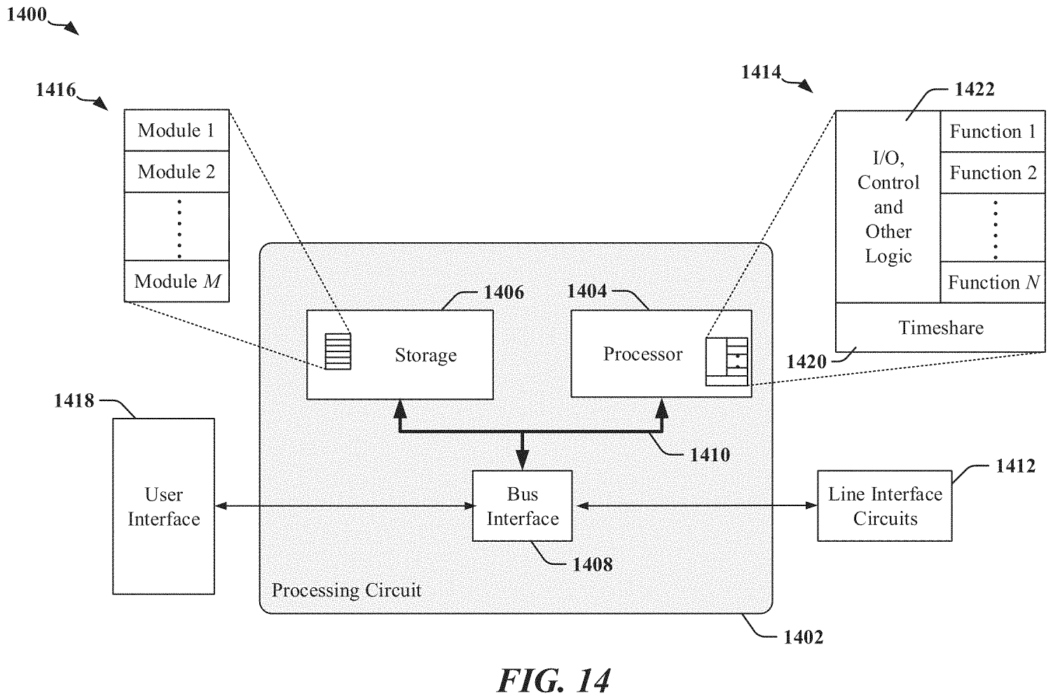

FIG. 14 is a diagram illustrating an example of a hardware implementation for an apparatus 1400 employing a processing circuit 1402 that may be configured to perform one or more functions disclosed herein. In accordance with various aspects of the disclosure, an element, or any portion of an element, or any combination of elements as disclosed herein may be implemented using the processing circuit 1402. The processing circuit 1402 may include one or more processors 1404 that are controlled by some combination of hardware and software modules. Examples of processors 1404 include microprocessors, microcontrollers, digital signal processors (DSPs), SoCs, ASICs, field programmable gate arrays (FPGAs), programmable logic devices (PLDs), state machines, sequencers, gated logic, discrete hardware circuits, and other suitable hardware configured to perform the various functionality described throughout this disclosure. The one or more processors 1404 may include specialized processors that perform specific functions, and that may be configured, augmented or controlled by one of the software modules 1416. The one or more processors 1404 may be configured through a combination of software modules 1416 loaded during initialization, and further configured by loading or unloading one or more software modules 1416 during operation. In various examples, the processing circuit 1402 may be implemented using a state machine, sequencer, signal processor and/or general-purpose processor, or a combination of such devices and circuits.

In the illustrated example, the processing circuit 1402 may be implemented with a bus architecture, represented generally by the bus 1410. The bus 1410 may include any number of interconnecting buses and bridges depending on the specific application of the processing circuit 1402 and the overall design constraints. The bus 1410 links together various circuits including the one or more processors 1404, and storage 1406. Storage 1406 may include memory devices and mass storage devices, and may be referred to herein as computer-readable media, computer-readable storage media, processor-readable media and/or processor-readable storage media. The bus 1410 may also link various other circuits such as timing sources, timers, peripherals, voltage regulators, and power management circuits. A bus interface 1408 may provide an interface between the bus 1410 and one or more transceivers 1412. A transceiver 1412 may be provided for each networking technology supported by the processing circuit. In some instances, multiple networking technologies may share some or all of the circuitry or processing modules found in a transceiver 1412. Each transceiver 1412 provides a means for communicating with various other apparatus over a transmission medium. Depending upon the nature of the apparatus 1400, a user interface 1418 (e.g., keypad, display, speaker, microphone, joystick) may also be provided, and may be communicatively coupled to the bus 1410 directly or through the bus interface 1408.

A processor 1404 may be responsible for managing the bus 1410 and for general processing that may include the execution of software stored in a computer-readable medium that may include the storage 1406. In this respect, the processing circuit 1402, including the processor 1404, may be used to implement any of the methods, functions and techniques disclosed herein. The storage 1406 may be used for storing data that is manipulated by the processor 1404 when executing software, and the software may be configured to implement any one of the methods disclosed herein.

One or more processors 1404 in the processing circuit 1402 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the storage 1406 or in an external computer-readable medium. The external computer-readable medium and/or storage 1406 may include a non-transitory computer-readable medium. A non-transitory computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a “flash drive,” a card, a stick, or a key drive), RAM, ROM, a programmable read-only memory (PROM), an erasable PROM (EPROM) including EEPROM, a register, a removable disk, and any other suitable medium for storing software and/or instructions that may be accessed and read by a computer. The computer-readable medium and/or storage 1406 may also include, by way of example, a carrier wave, a transmission line, and any other suitable medium for transmitting software and/or instructions that may be accessed and read by a computer. Computer-readable medium and/or the storage 1406 may reside in the processing circuit 1402, in the processor 1404, external to the processing circuit 1402, or be distributed across multiple entities including the processing circuit 1402. The computer-readable medium and/or storage 1406 may be embodied in a computer program product. By way of example, a computer program product may include a computer-readable medium in packaging materials. Those skilled in the art will recognize how best to implement the described functionality presented throughout this disclosure depending on the particular application and the overall design constraints imposed on the overall system.

The storage 1406 may maintain software maintained and/or organized in loadable code segments, modules, applications, programs, etc., which may be referred to herein as software modules 1416. Each of the software modules 1416 may include instructions and data that, when installed or loaded on the processing circuit 1402 and executed by the one or more processors 1404, contribute to a run-time image 1414 that controls the operation of the one or more processors 1404. When executed, certain instructions may cause the processing circuit 1402 to perform functions in accordance with certain methods, algorithms and processes described herein.

Some of the software modules 1416 may be loaded during initialization of the processing circuit 1402, and these software modules 1416 may configure the processing circuit 1402 to enable performance of the various functions disclosed herein. For example, some software modules 1416 may configure internal devices and/or logic circuits 1422 of the processor 1404, and may manage access to external devices such as the transceiver 1412, the bus interface 1408, the user interface 1418, timers, mathematical coprocessors, and so on. The software modules 1416 may include a control program and/or an operating system that interacts with interrupt handlers and device drivers, and that controls access to various resources provided by the processing circuit 1402. The resources may include memory, processing time, access to the transceiver 1412, the user interface 1418, and so on.

One or more processors 1404 of the processing circuit 1402 may be multifunctional, whereby some of the software modules 1416 are loaded and configured to perform different functions or different instances of the same function. The one or more processors 1404 may additionally be adapted to manage background tasks initiated in response to inputs from the user interface 1418, the transceiver 1412, and device drivers, for example. To support the performance of multiple functions, the one or more processors 1404 may be configured to provide a multitasking environment, whereby each of a plurality of functions is implemented as a set of tasks serviced by the one or more processors 1404 as needed or desired. In one example, the multitasking environment may be implemented using a timesharing program 1420 that passes control of a processor 1404 between different tasks, whereby each task returns control of the one or more processors 1404 to the timesharing program 1420 upon completion of any outstanding operations and/or in response to an input such as an interrupt. When a task has control of the one or more processors 1404, the processing circuit is effectively specialized for the purposes addressed by the function associated with the controlling task. The timesharing program 1420 may include an operating system, a main loop that transfers control on a round-robin basis, a function that allocates control of the one or more processors 1404 in accordance with a prioritization of the functions, and/or an interrupt driven main loop that responds to external events by providing control of the one or more processors 1404 to a handling function.

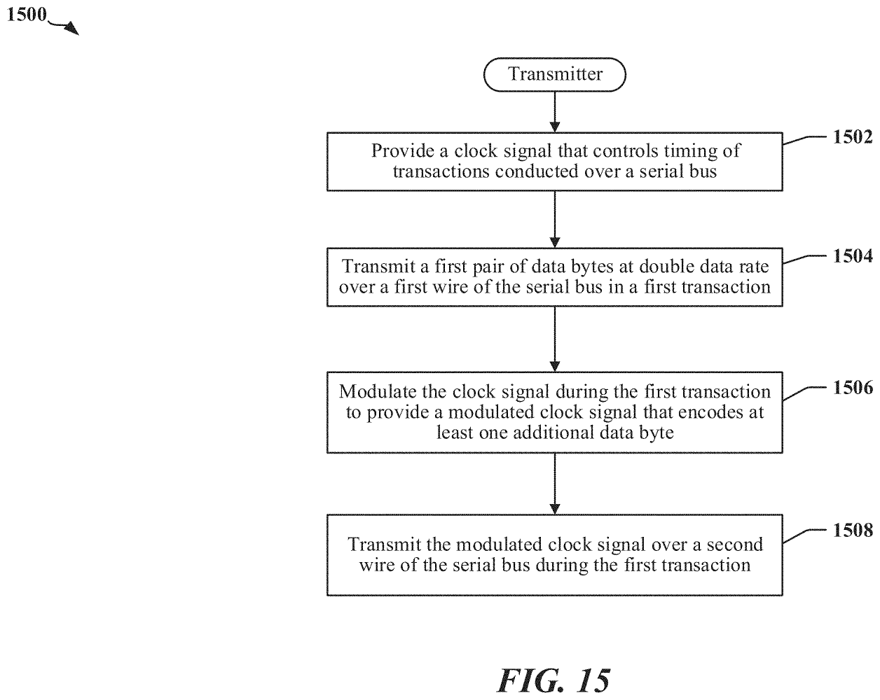

FIG. 15 is a flowchart 1500 illustrating a process that may be performed at a device coupled to a serial bus.

At block 1502, the device may provide a clock signal that controls timing of transactions conducted over a serial bus. At block 1504, the device may transmit a first pair of data bytes at double data rate over a first wire of the serial bus in a first transaction. At block 1506, the device may modulate the clock signal during the first transaction to provide a modulated clock signal that encodes at least one additional data byte. At block 1508, the device may transmit the modulated clock signal over a second wire of the serial bus during the first transaction.

In some implementations, the device may transmit a second pair of data bytes at double data rate signal over the first wire of the serial bus in a second transaction, and transmit the clock signal over the second wire of the serial bus during the second transaction. The second transaction may be conducted in accordance with an I3C HDR-DDR protocol. The device may serialize the first pair of data bytes to obtain a serialized bit stream, and provide the serialized bit stream in a frame that has a format defined by the I3C double data rate protocol.

In one example, the device may serialize the first pair of data bytes to obtain a serialized bit stream, insert a parity bit after each data byte in the serialized bit stream, and provide preamble bits in the serialized bit stream to indicate location of parity bits in the serialized bit stream.

In certain examples, the device may transmit preamble bits in the first transaction to indicate that the modulated clock signal is being transmitted over the second wire of the serial bus. The preamble bits may be configured to indicate a type of modulation used to encode the at least one additional data byte.

In some examples, the device may transmit a command code in the first transaction, the command code indicating that the modulated clock signal is being transmitted over the second wire of the serial bus. The device may serialize the first pair of data bytes to obtain a serialized bit stream, insert a parity bit after each data byte in the serialized bit stream, and provide a command code in the serialized bit stream to indicate a format of a frame used to carry the serialized bit stream.

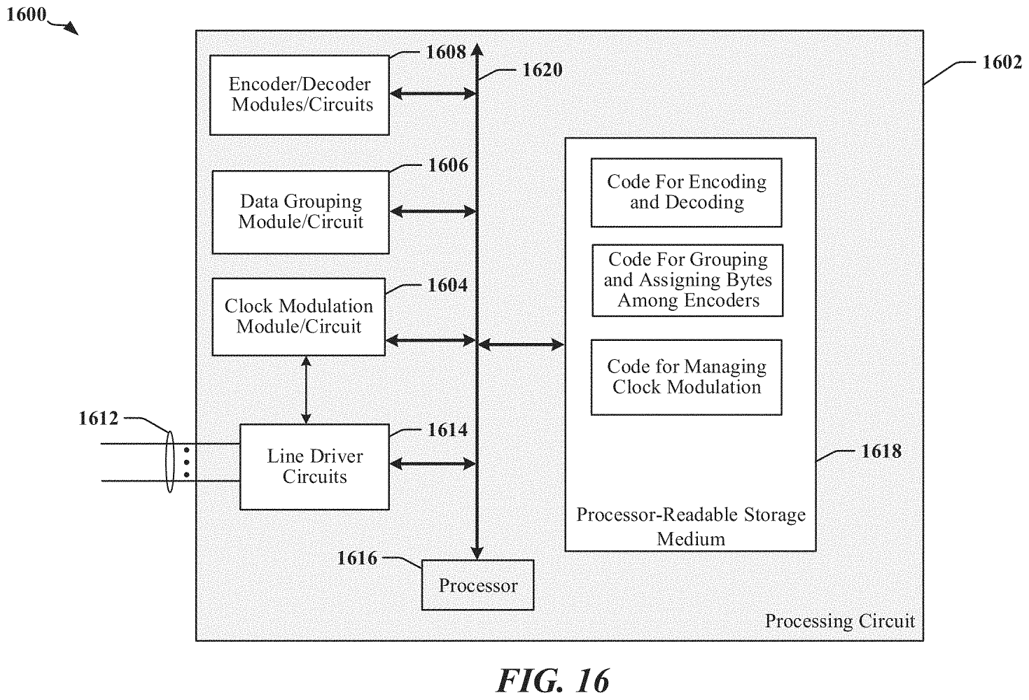

FIG. 16 is a diagram illustrating a simplified example of a hardware implementation for an apparatus 1600 employing a processing circuit 1602. The processing circuit typically has a controller or processor 1616 that may include one or more microprocessors, microcontrollers, digital signal processors, sequencers and/or state machines. The processing circuit 1602 may be implemented with a bus architecture, represented generally by the bus 1620. The bus 1620 may include any number of interconnecting buses and bridges depending on the specific application of the processing circuit 1602 and the overall design constraints. The bus 1620 links together various circuits including one or more processors and/or hardware modules, represented by the controller or processor 1616, the modules or circuits 1604, 1606 and 1608, and the computer-readable storage medium 1618. The apparatus may be coupled to a communication link using a physical layer circuit 1614. The physical layer circuit 1614 may operate a serial link 1612 to support communications in accordance with I3C protocols. The bus 1620 may also link various other circuits such as timing sources, peripherals, voltage regulators, and power management circuits, which are well known in the art, and therefore, will not be described any further.

The processor 1616 is responsible for general processing, including the execution of software, code and/or instructions stored on the computer-readable storage medium 1618. The computer-readable storage medium may include a non-transitory storage medium. The software, when executed by the processor 1616, causes the processing circuit 1602 to perform the various functions described supra for any particular apparatus. The computer-readable storage medium may be used for storing data that is manipulated by the processor 1616 when executing software. The processing circuit 1602 further includes at least one of the modules 1604, 1606 and 1608. The modules 1604, 1606 and 1608 may be software modules running in the processor 1616, resident/stored in the computer-readable storage medium 1618, one or more hardware modules coupled to the processor 1616, or some combination thereof. The modules 1604, 1606 and 1608 may include microcontroller instructions, state machine configuration parameters, or some combination thereof.

In one configuration, the apparatus 1600 includes modules and/or circuits 1604, 1608 configured to encode data in a clock signal transmitted over the serial link 1612, modules and/or circuits 1608 configured to encode data in a DDR signal transmitted over the serial link 1612, and modules and/or circuits 1606 configured to group bytes for transmission in the DDR signal and/or clock signal.

A processor 1616 of the apparatus 1600 may be configured to provide a clock signal that controls timing of transactions conducted over a serial bus, transmit a first pair of data bytes at double data rate over a first wire of the serial bus in a first transaction, modulate the clock signal during the first transaction to provide a modulated clock signal that encodes at least one additional data byte, and transmit the modulated clock signal over a second wire of the serial bus during the first transaction. The processor 1616 may be further configured to transmit a second pair of data bytes at double data rate signal over the first wire of the serial bus in a second transaction, and transmit the clock signal over the second wire of the serial bus during the second transaction. The second transaction may be conducted in accordance with an I3C double data rate protocol. The processor 1616 may be further configured to serialize the first pair of data bytes to obtain a serialized bit stream, and provide the serialized bit stream in a frame that has a format defined by the I3C double data rate protocol.

The processor 1616 may be further configured to serialize the first pair of data bytes to obtain a serialized bit stream, insert a parity bit after each data byte in the serialized bit stream, and provide preamble bits in the serialized bit stream to indicate location of parity bits in the serialized bit stream.

The processor 1616 may be further configured to transmit preamble bits in the first transaction to indicate that the modulated clock signal is being transmitted over the second wire of the serial bus. The preamble bits may be configured to indicate a type of modulation used to encode the at least one additional data byte.

The processor 1616 may be further configured to transmit a command code in the first transaction. The command code may indicate that the modulated clock signal is being transmitted over the second wire of the serial bus.

The processor 1616 may be further configured to serialize the first pair of data bytes to obtain a serialized bit stream, insert a parity bit after each data byte in the serialized bit stream, and provide a command code in the serialized bit stream to indicate a format of a frame used to carry the serialized bit stream.

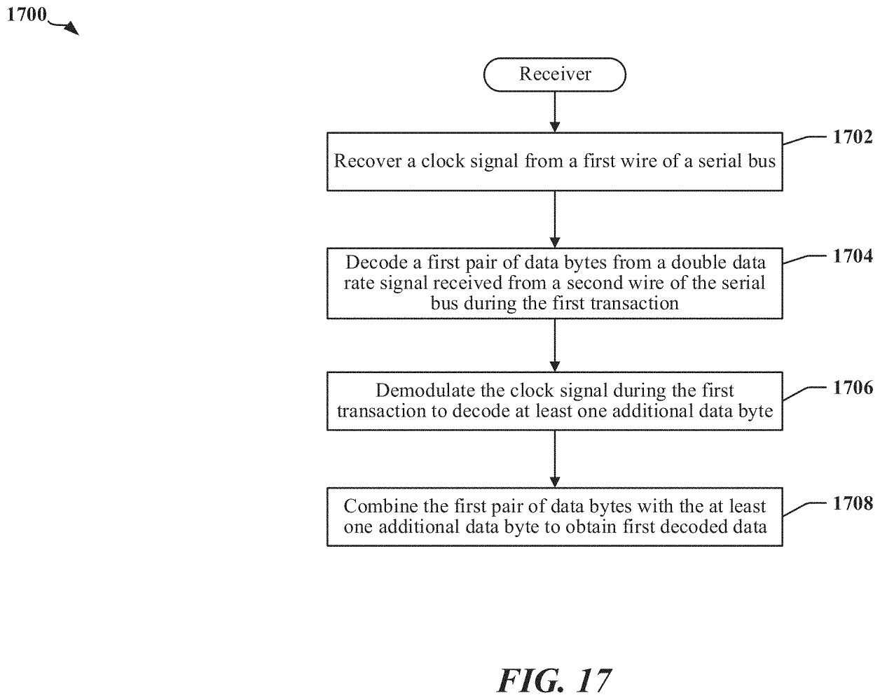

FIG. 17 is a flowchart 1700 illustrating a process that may be performed at a device coupled to a serial bus.

At block 1702, the device may recover a clock signal from a first wire of a serial bus. At block 1704, the device may decode a first pair of data bytes from a double data rate signal received from a second wire of the serial bus during the first transaction. At block 1706, the device may demodulate the clock signal during the first transaction to decode at least one additional data byte. At block 1708, the device may combine the first pair of data bytes with the at least one additional data byte to obtain first decoded data. In some instances, the first pair of data bytes is decoded from the double data rate signal using vector decoding.

In some implementations, the device may decode a second pair of data bytes from the double data rate signal during a second transaction, and provide the second pair of data bytes as second decoded data. The second transaction may be conducted in accordance with an I3C double data rate protocol. The first pair of data bytes may be received in a frame that has a format defined by the I3C double data rate protocol.

In one example, the device may receive a parity bit after each data byte received from the double data rate signal. A first data byte of the first pair of data bytes may be received in its entirety from the double data rate signal before a second data byte of the first pair of data bytes is transmitted.

In certain examples, the device may receive preamble bits in the first transaction indicating that the modulated clock signal is being transmitted over the second wire of the serial bus. The preamble bits may be configured to indicate a type of modulation used to encode the at least one additional data byte.

In one example, the device may receive a command code in the first transaction, the command code indicating that the modulated clock signal is being transmitted over the second wire of the serial bus.

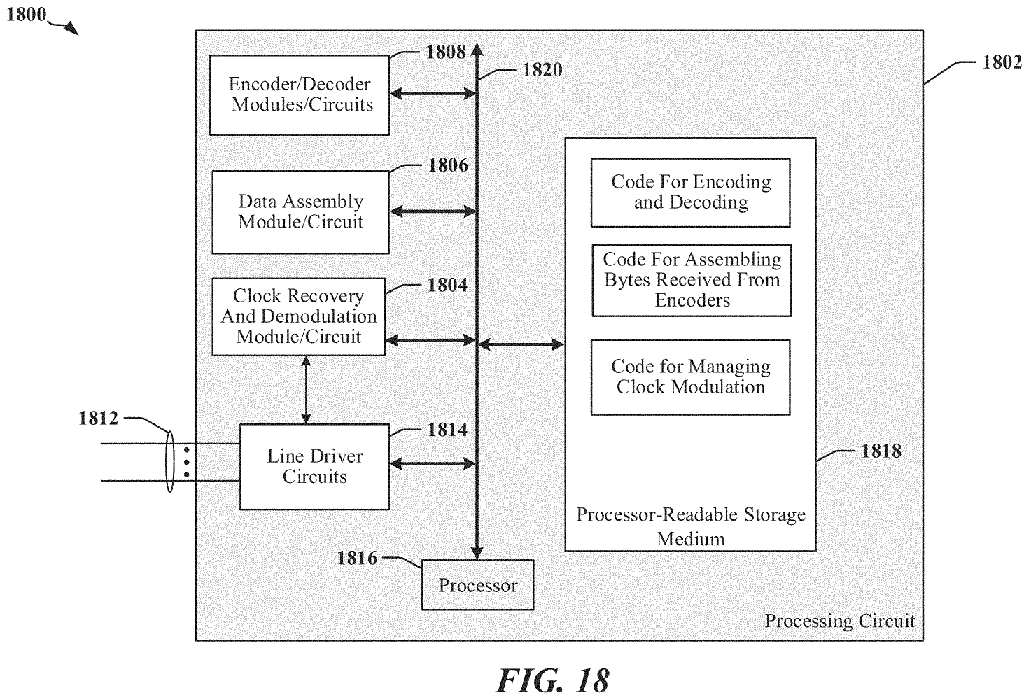

FIG. 18 is a diagram illustrating a simplified example of a hardware implementation for an apparatus 1800 employing a processing circuit 1802. The processing circuit typically has a controller or processor 1816 that may include one or more microprocessors, microcontrollers, digital signal processors, sequencers and/or state machines. The processing circuit 1802 may be implemented with a bus architecture, represented generally by the bus 1820. The bus 1820 may include any number of interconnecting buses and bridges depending on the specific application of the processing circuit 1802 and the overall design constraints. The bus 1820 links together various circuits including one or more processors and/or hardware modules, represented by the controller or processor 1816, the modules or circuits 1804, 1806 and 1808, and the computer-readable storage medium 1818. The apparatus may be coupled to a communication link using a physical layer circuit 1814. The physical layer circuit 1814 may operate a serial link 1812 to support communications in accordance with I3C protocols. The bus 1820 may also link various other circuits such as timing sources, peripherals, voltage regulators, and power management circuits, which are well known in the art, and therefore, will not be described any further.

The processor 1816 is responsible for general processing, including the execution of software, code and/or instructions stored on the computer-readable storage medium 1818. The computer-readable storage medium may include a non-transitory storage medium. The software, when executed by the processor 1816, causes the processing circuit 1802 to perform the various functions described supra for any particular apparatus. The computer-readable storage medium may be used for storing data that is manipulated by the processor 1816 when executing software. The processing circuit 1802 further includes at least one of the modules 1804, 1806 and 1808. The modules 1804, 1806 and 1808 may be software modules running in the processor 1816, resident/stored in the computer-readable storage medium 1818, one or more hardware modules coupled to the processor 1816, or some combination thereof. The modules 1804, 1806 and 1808 may include microcontroller instructions, state machine configuration parameters, or some combination thereof.

In one configuration, the apparatus 1800 includes modules and/or circuits 1804, 1808 configured to decode data in a clock signal received from the serial link 1812, modules and/or circuits 1808 configured to decode data in a DDR signal received from the serial link 1812, and modules and/or circuits 1806 configured to reassemble bytes decoded from the DDR signal and/or clock signal.

A processor 1816 of the apparatus 1800 may be configured to recover a clock signal from a first wire of a serial bus, decode a first pair of data bytes from a double data rate signal received from a second wire of the serial bus during the first transaction, demodulate the clock signal during the first transaction to decode at least one additional data byte, and combine the first pair of data bytes with the at least one additional data byte to obtain first decoded data. In some instances, a vector decoder may be employed to decode the first pair of data bytes.

The processor 1816 may be further configured to decode a second pair of data bytes from the double data rate signal during a second transaction, and provide the second pair of data bytes as second decoded data. The second transaction may be conducted in accordance with an I3C double data rate protocol. The first pair of data bytes may be received in a frame that has a format defined by the I3C double data rate protocol.

The processor 1816 may be further configured to receive a parity bit after each data byte received from the double data rate signal. A first data byte of the first pair of data bytes is received in its entirety from the double data rate signal before a second data byte of the first pair of data bytes is transmitted.

The processor 1816 may be further configured to receive preamble bits in the first transaction indicating that the modulated clock signal is being transmitted over the second wire of the serial bus. The preamble bits may be configured to indicate a type of modulation used to encode the at least one additional data byte.

The processor 1816 may be further configured to receive a command code in the first transaction, the command code indicating that the modulated clock signal is being transmitted over the second wire of the serial bus.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

1. A data communication method, comprising:
providing a clock signal that controls timing of transactions conducted over a serial bus;
transmitting a first pair of data bytes at double data rate over a first wire of the serial bus in a first transaction;
modulating the clock signal during the first transaction to provide a modulated clock signal that encodes at least one additional data byte; and
transmitting the modulated clock signal over a second wire of the serial bus during the first transaction.

2. The data communication method of claim 1, further comprising:
transmitting a second pair of data bytes at double data rate over the first wire of the serial bus in a second transaction; and
transmitting the clock signal over the second wire of the serial bus during the second transaction, wherein the second transaction is conducted in accordance with an I3C double data rate protocol.

3. The data communication method of claim 2, further comprising:
serializing the first pair of data bytes to obtain a serialized bit stream; and
providing the serialized bit stream in a frame that has a format defined by the I3C double data rate protocol.

4. The data communication method of claim 1, further comprising:
serializing the first pair of data bytes to obtain a serialized bit stream;
inserting a parity bit after each data byte in the serialized bit stream; and
providing preamble bits in the serialized bit stream to indicate location of parity bits in the serialized bit stream.

5. The data communication method of claim 1, further comprising:
transmitting preamble bits in the first transaction to indicate that the modulated clock signal is being transmitted over the second wire of the serial bus.

6. The data communication method of claim 5, wherein the preamble bits are configured to indicate a type of modulation used to encode the at least one additional data byte.

7. The data communication method of claim 1, further comprising:
transmitting a command code in the first transaction, the command code indicating that the modulated clock signal is being transmitted over the second wire of the serial bus.

8. The data communication method of claim 1, further comprising:
serializing the first pair of data bytes to obtain a serialized bit stream;
inserting a parity bit after each data byte in the serialized bit stream; and
providing a command code in the serialized bit stream to indicate a format of a frame used to carry the serialized bit stream.

9. A data communication apparatus, comprising:
a bus interface adapted to couple the apparatus to a serial bus; and
a processor configured to:
provide a clock signal that controls timing of transactions conducted over the serial bus;
transmit a first pair of data bytes at double data rate over a first wire of the serial bus in a first transaction;
modulate the clock signal during the first transaction to provide a modulated clock signal that encodes at least one additional data byte; and
transmit the modulated clock signal over a second wire of the serial bus during the first transaction.

10. The data communication apparatus of claim 9, wherein the processor is further configured to:
transmit a second pair of data bytes at double data rate over the first wire of the serial bus in a second transaction; and
transmit the clock signal over the second wire of the serial bus during the second transaction, wherein the second transaction is conducted in accordance with an I3C double data rate protocol.

11. The data communication apparatus of claim 10, wherein the processor is further configured to:
serialize the first pair of data bytes to obtain a serialized bit stream; and
provide the serialized bit stream in a frame that has a format defined by the I3C double data rate protocol.

12. The data communication apparatus of claim 9, wherein the processor is further configured to:
serialize the first pair of data bytes to obtain a serialized bit stream;
insert a parity bit after each data byte in the serialized bit stream; and
provide preamble bits in the serialized bit stream to indicate location of parity bits in the serialized bit stream.

13. The data communication apparatus of claim 9, wherein the processor is further configured to:
transmit preamble bits in the first transaction to indicate that the modulated clock signal is being transmitted over the second wire of the serial bus.

14. The data communication apparatus of claim 13, wherein the preamble bits are configured to indicate a type of modulation used to encode the at least one additional data byte.

15. The data communication apparatus of claim 9, wherein the processor is further configured to:
transmit a command code in the first transaction, the command code indicating that the modulated clock signal is being transmitted over the second wire of the serial bus.

16. The data communication apparatus of claim 9, wherein the processor is further configured to:
serialize the first pair of data bytes to obtain a serialized bit stream;
insert a parity bit after each data byte in the serialized bit stream; and
provide a command code in the serialized bit stream to indicate a format of a frame used to carry the serialized bit stream.

17. A data communication method, comprising:
recovering a clock signal from a first wire of a serial bus;
decoding a first pair of data bytes from a double data rate signal received from a second wire of the serial bus during a first transaction;
demodulating the clock signal during the first transaction to decode at least one additional data byte; and
combining the first pair of data bytes with the at least one additional data byte to obtain first decoded data.

18. The data communication method of claim 17, further comprising:
decoding a second pair of data bytes from the double data rate signal during a second transaction; and
providing the second pair of data bytes as second decoded data, wherein the second transaction is conducted in accordance with an I3C double data rate protocol.

19. The data communication method of claim 17, wherein the first pair of data bytes is decoded from the double data rate signal using vector decoding.

20. The data communication method of claim 17, further comprising:
receiving a parity bit after each data byte received from the double data rate signal, wherein a first data byte of the first pair of data bytes is received in its entirety from the double data rate signal before a second data byte of the first pair of data bytes is transmitted.

21. The data communication method of claim 17, further comprising:
receiving preamble bits in the first transaction indicating that a modulated clock signal is being transmitted over the first wire of the serial bus.

22. The data communication method of claim 21, wherein the preamble bits are configured to indicate a type of modulation used to encode the at least one additional data byte.

23. The data communication method of claim 17, further comprising:
receiving a command code in the first transaction, the command code indicating that a modulated clock signal is being transmitted over the first wire of the serial bus.

24. A data communication apparatus, comprising:
a bus interface adapted to couple the apparatus to a serial bus; and
a protocol controller configured to:
recover a clock signal from a first wire of the serial bus;
decode a first pair of data bytes from a double data rate signal received from a second wire of the serial bus during a first transaction;
demodulate the clock signal during the first transaction to decode at least one additional data byte; and
combine the first pair of data bytes with the at least one additional data byte to obtain first decoded data.

25. The data communication apparatus of claim 24, wherein the protocol controller is further configured to:
decode a second pair of data bytes from the double data rate signal during a second transaction; and
provide the second pair of data bytes as second decoded data,
wherein the second transaction is conducted in accordance with an I3C double data rate protocol.

26. The data communication apparatus of claim 24, wherein the protocol controller comprises:
a vector decoder configured to decode the first pair of data bytes from the double data rate signal.

27. The data communication apparatus of claim 24, wherein the protocol controller is further configured to:
receive a parity bit after each data byte received from the double data rate signal, wherein a first data byte of the first pair of data bytes is received in its entirety from the double data rate signal before a second data byte of the first pair of data bytes is transmitted.

28. The data communication apparatus of claim 24, wherein the protocol controller is further configured to:
receive preamble bits in the first transaction indicating that a modulated clock signal is being transmitted over the first wire of the serial bus.

29. The data communication apparatus of claim 28, wherein the preamble bits are configured to indicate a type of modulation used to encode the at least one additional data byte.

30. The data communication apparatus of claim 24, wherein the protocol controller is further configured to:
receive a command code in the first transaction, the command code indicating that a modulated clock signal is being transmitted over the first wire of the serial bus.
